(19) United States
(12) Patent Application Publication
(10) Pub. No.: US 2013/0318285 A1
(43) Pub. Date: Nov. 28, 2013

(54) FLASH MEMORY CONTROLLER

(71) Applicant: David J. Pignatelli, Saratoga, CA (US)

(72) Inventor: David J. Pignatelli, Saratoga, CA (US)

(73) Assignee: VIOLIN MEMORY INC, Mountain View, CA (US)

(21) Appl. No.: 13/833,643

(22) Filed: Mar. 15, 2013

Related U.S. Application Data
(60) Provisional application No. 61/650,604, filed on May 23, 2012.

(51) Int. Cl. G06F 12/02

(52) U.S. Cl. CPC G06F 12/0246
USPC 711/103

(57) ABSTRACT

An apparatus and method of managing the operation of a plurality of FLASH chips provides for a physical layer (PHY) interface to a FLASH memory circuit having a plurality of FLASH chips having a common interface bus. The apparatus has a PHY for controlling the voltages on the interface pins in accordance with a microprogrammable state machine. A data transfer in progress over the bus may be interrupted to perform another command to another chip on the shared bus and the data transfer may be resumed after completion of the another command.

This application claims the benefit of U.S. 61/650,604, filed in May 23, 2012, which is incorporated herein by reference.

### FIELD OF THE INVENTION

The present application may relate to the storage of data in a computer memory system.

### BACKGROUND

NAND FLASH memory is electrically organized as a plurality of blocks on a die (chip), and a plurality of dies may be incorporated into a package, which may be termed a FLASH memory circuit. The chip may have more than one plane so as to be separately addressable for erase, write and read operations. A block is comprised of a plurality of pages, and the pages are comprised of a plurality of sectors. Some of this terminology is a legacy from hard disk drive (HDD) technology; however, as used in FLASH memory devices, some adaptation is made. NAND FLASH memory is characterized in that data may be written to a sector of memory, or to a contiguous group of sectors comprising a page. Pages can be written in order within a block, but if page is omitted, the present technology does not permit writing to the omitted page until the entire block has been erased. This contrasts with disk memory where a change to data in a memory location may be made by writing to that location, regardless of the previous state of the location. A block is the smallest extent of FLASH memory that can be erased, and a block must be erased prior to being written (programmed) with data.

Earlier versions of NAND FLASH had the capability of writing sequentially to sectors of a page, and data may be written on a sector basis where the die architecture permits this to be done. More recently, memory circuit manufacturers are evolving the device architecture so that one or more pages of data may be written in a write operation. This includes implementations where the die has two planes and the planes may be written simultaneously. All of this is by way of saying that the specific constraints on reading or writing data may be device dependent, but the overall approach disclosed herein may be easily adapted by a person of skill in the art so as to accommodate specific device features. The terms “erase” and “write” in a FLASH memory have the characteristic that when an erase or a write operation is in progress, a plane of the FLASH memory chip on which the operation is being performed is not available for “read” operations to any location in a plane of the chip.

One often describes stored user data by the terms sector, page, and block, but there is additional housekeeping data that is also stored and which must be accommodated in the overall memory system design. Auxiliary data such as metadata, error correcting codes and the like that are related in some way to stored data is often said to be stored in a “spare” area. However, in general, the pages of a block or the block of data may be somewhat arbitrarily divided into physical memory extents that may be used for data, or for auxiliary data. So there is some flexibility in the amount of memory that is used for data and for auxiliary data in a block of data, and this is managed by some form of operating system abstraction, usually in one or more controllers associated with a memory chip, or with a module that includes the memory chip. The auxiliary data is stored in a spare area which may be allocated on a sector, a page, or a block basis.

The management of reading of data, writing of data, and the background operations such as wear leveling and garbage collection, are performed by a system controller, using an abstraction termed a flash translation layer (FTL) that maps logical addresses, as understood by the user, to the physical addresses of the memory where the data values are actually stored. The generic details of a FTL are known to a person of skill in the art and are not described in detail herein. The use of a FTL or equivalent is assumed, and this discussion takes the view that the abstraction of the FTL is equivalent of mapping the address of a page of user data to a physical memory location. The location may be a page of a block. This is not intended to be a limitation, but such an assumption simplifies the discussion herein.

To support a new NAND Flash component on a platform, host software and hardware changes are often required. Implementing these changes can be costly, due to design changes and testing cycles. Some of the interface characteristics have been standardized, some are in the process of being standardized, and some are particular to a manufacturer as the memory technology evolves, in capacity, density and speed. While the speed of writing and reading from a Flash memory cell may decrease as the design rule becomes smaller and the number of bits per cell increases, the speed of data transfer may increase.

The Open NAND Flash Interface (ONFI) Working group, an industry consortium, has issued an ONFI NAND v 1.0 specification which defines a 50 MT/s transfer rate, a twenty percent improvement over legacy NAND 40 MT/s transfer rate. In the second generation, ONFI 2.2, an asynchronous single data rate version was introduced, with a 50 MT/s maximum transfer speed, while the maximum transfer speed for the synchronous DDR version increased to 200 MT/s. In the most recently announced specification, ONFI 2.3, a new error corrected NAND (ECC Zero NAND) was introduced in which the NAND device performs error correction and provides corrected data to the host. The specification includes both MLC and SLC NAND, and defines a single data rate asynchronous device and a double data rate synchronous device with data transfer speeds that match those of ONFI v 2.2. ONFI v 3.0 has been announced, with a targeted interface speed of 400 MT/s.

Megatransfers (MT) per second refers to the number of data transfers (or data samples) per second, with each sample occurring at the clock edge. In a double data rate system, the data is transferred on both the rising and falling edge of the clock signal. This is usually considered to be a nominal rate and may vary in practice.

Toggle Mode NAND, with products available from Samsung and Toshiba, is an asynchronous double data rate (DDR) NAND design without a separate clock signal. This interface may enable a lower power solution than typical synchronous double data rate memory chip designs and retains may interface similarities to older NAND interface designs.

JEDEC is also attempting to forge an agreement on a standard interface. However, the rapid evolution of the NAND Flash memory technology suggests that there will continue to be a variety of “non-standard” components being available, particularly for new products emphasizing an aspect of the technology.

Since it uses an asynchronous interface similar to that used in conventional NAND, the Toshiba DDR Toggle Mode NAND, for example, requires no clock signal, which means that it uses less power and has a simpler system design compared to competing synchronous NAND alternatives. The nominal data transfer speed may be up to 400 MT/s. The bidirectional DQS signal that controls the read and write enable functions in Toggle Mode NAND only consumes power during a read or write operation. In synchronous DDR NAND, the clock signal is continuous, and often uses more power

The DDR Toggle Mode NAND interface uses a bidirectional DQS (data strobe) signal to control the data interface timing. The DQS signal is driven by the host when it is writing data to the NAND memory and is driven by the NAND memory when the NAND memory is sending to the host. Each rising and falling edge of the DQS signal is associated with a data transfer. The DQS signal may be considered to be “source synchronous.” That is, the DQS signal is provided by the device that is sourcing the data.

The size of the data page that is written continues to increase, with 8 KB pages being common today, and 16 KB pages being discussed. As long as full-page transfers used, the transfer efficiency is achieved. However, most applications today rely on partial page reads to minimize the transfer overhead. The number of chips that are being included in a package continues to increase, so that the overall capacity of the single device is greater. However, the number of pins on a device of a given size is limited, and thus some of the functions of the chips in the package may need to be controlled by multiplexed means. This could include the chip enable function. Effectively, the increase in memory density is being achieved with a constant number of interface pins, so the demand for throughtput for each pin is significantly greater.

Nevertheless, the program times, the read times, and the need for error correcting code robustness all show an increasing trend due the reduction in process node size, and the increase in the number of bits that are being stored in each memory chip or multichip package. In this sense, NAND Flash is evolving, at the moment, in a direction that is not typical of semiconductor technologies.

For purposes of this specification, the architecture of a NAND memory chip, and the aggregation of such memory chips into a package is discussed generically, as there are many variations in detail between the available products, and this is likely to continue for some time.

### SUMMARY

A storage system using FLASH memory is disclosed that uses a high degree of parallelism in communicating with and operating FLASH memory circuits so as to adapt the operation of the relatively slow FLASH chips to applications where a lower latency is desired. The parallelism is realized in a hierarchical manner using a plurality of physical signaling channels connected to multiple FLASH Memory devices, where there may be an additional level of parallelism when multiple chips (DIE) are included in each FLASH memory device. Concurrency requirements may result in a plurality of devices and device types (PHYs, Memory Packages, and DIE) processing access commands simultaneously.

A shared physical signaling channel presents a bottleneck for command issuance when long transfers of data occupy the channel. Such long data transfers may be interruptible without losing the original command context to allow commands to be issued to other devices to keep them busy.

A FLASH Controller Device, is described using an interruptible microcoded state machine engine to provide these features.

An apparatus for storing digital data, is disclosed, having a controller, a FLASH memory controller, the FLASH memory controller in communication with the controller and with a plurality of FLASH memory circuits. A write data transfer between the FLASH memory controller and a FLASH memory circuit of the plurality of FLASH memory circuits is interruptible. In an aspect, the controller and the FLASH memory controller may share a processor and a buffer memory. The FLASH memory controller may have a state machine configured to manage the communication with the FLASH memory circuits.

The FLASH memory circuit may be a plurality of FLASH memory chips sharing a common bus. a write data transfer between the FLASH memory controller and a FLASH memory circuit may be resumably interruptible when a read command is received by the FLASH memory controller and is directed to a same FLASH memory circuit as the write data transfer.

In an aspect, the write data transfer may be resumably interruptible to poll the FLASH memory circuit for completion of the read command. The write data transfer may be resumably interruptible to permit transfer the results of a completed read command from a buffer of the FLASH memory circuit to the FLASH memory controller.

A method of managing a FLASH memory device is described including, providing a processor operable to manage a queue of read requests, write requests and data associated with the write requests; transmitting the write request and the associated data to a FLASH memory interface; sending a read request to the FLASH memory interface and: determining if a write data transfer is in progress to a same memory circuit as is identified by the read request.

The method may further comprise interrupting the write data transfer to send the read request to the FLASH memory circuit; resuming the write data transfer; waiting for an estimated time to perform the read request; determining if a write data transfer is in progress; interrupting the write data transfer; polling the memory circuit to determine if there is data in a read buffer; and, if data is in the read buffer, transferring the data from the read buffer to the FLASH memory interface; and, resuming a previously interrupted write data transfer.

In another aspect, the method may include transmitting the write data to the FLASH memory device prior to transmitting a write command.

In yet another aspect, an apparatus for interfacing with a FLASH memory circuit, may include a controller configured to queue READ and WRITE commands and associated WRITE data, and to receive data in response to a READ command, the controller being adapted to interface with a user and with a physical layer interface (PHY). The PHY may have a state machine executing a microcode program and configured to provide signals for controlling a FLASH memory circuit having a plurality of chips and for transmitting and receiving commands and data on a FLASH memory circuit bus interface. The PHY may be operable to interrupt a data transfer to the FLASH memory circuit to permit the execution of another command and to resume the data transfer after completion of the another command.

The data transfer may be of data to be written to a chip of the FLASH memory circuit, and the another command may be selected from a READ command, a POLL command, or a READ data transfer command, and directed to the FLASH memory circuit.

### BRIEF DESCRIPTION OF THE DRAWINGS

FIG. 1 is a portion of a block diagram of a memory system showing a plurality of FLASH chips (PHY) sharing common buses;

FIG. 2 shows the controller communicating with the PHY Control/Status Bus;

FIG. 3 shows a functional block diagram of the PHY interface controller;

FIG. 4 shows a PHY controller functional block diagram;

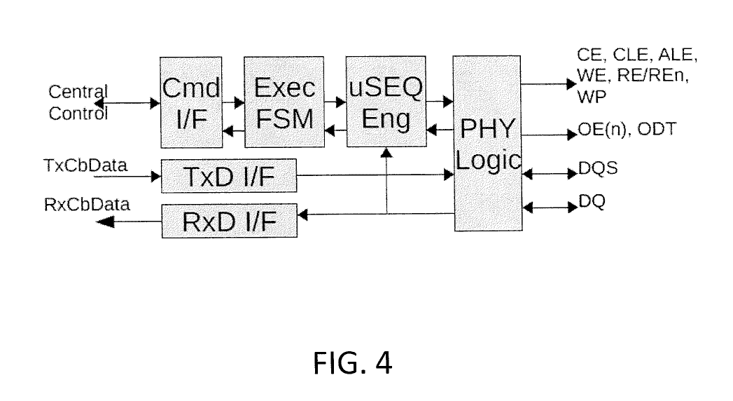

FIG. 5 shows an example of the command interface state diagram;

FIG. 6 shows an example of the FSM state transition diagram;

FIG. 7 is an example of a microsequencer block diagram;

FIG. 8 is an example of a PHY logic diagram; and

FIG. 9 is an example of a typical DDR pin output macro and timing diagram.

### DESCRIPTION

Exemplary embodiments may be better understood with reference to the drawings, but these embodiments are not intended to be of a limiting nature. Like numbered elements in the same or different drawings perform equivalent functions. Elements may be either numbered or designated by acronyms, or both, and the choice between the representation is made merely for clarity, so that an element designated by a numeral, and the same element designated by an acronym or alphanumeric indicator should not be distinguished on that basis.

It will be appreciated that the methods described and the apparatus shown in the figures may be configured or embodied in machine-executable instructions, e.g. software, or in hardware, or in a combination of both. The machine-executable instructions can be used to cause a general-purpose computer, a special-purpose processor, such as a DSP or array processor, or the like, that acts on the instructions to perform functions described herein. Alternatively, the operations might be performed by specific hardware components that may have hardwired logic or firmware instructions for performing the operations described, or by any combination of programmed computer components and custom hardware components, which may include analog circuits.

The methods may be provided, at least in part, as a computer program product that may include a non-volatile machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions or data for execution by a computing machine or special-purpose hardware and that may cause the machine or special purpose hardware to perform any one of the methodologies or functions of the present invention. The term “machine-readable medium” shall accordingly be taken include, but not be limited to, solid-state memories, optical and magnetic disks, magnetic memories, and optical memories, as well as any equivalent device that may be developed for such purpose.

For example, but not by way of limitation, a machine readable medium may include read-only memory (ROM); random access memory (RAM) of all types (e.g., S-RAM, D-RAM. P-RAM); programmable read only memory (PROM); electronically alterable read only memory (EPROM); magnetic random access memory; magnetic disk storage media; flash memory, which may be NAND or NOR configured; memory resistors; or electrical, optical, acoustical data storage medium, or the like. A volatile memory device such as DRAM may be used to store the computer program product provided that the volatile memory device is part of a system having a power supply, and the power supply or a battery provides power to the circuit for the time period during which the computer program product is stored on the volatile memory device.

Furthermore, it is common in the art to speak of software, in one form or another (e.g., program, procedure, process, application, module, algorithm or logic), as taking an action or causing a result. Such expressions are merely a convenient way of saying that execution of the instructions of the software by a computer or equivalent device causes the processor of the computer or the equivalent device to perform an action or a produce a result, as is well known by persons skilled in the art.

A person of skill in the art would understand that error cases than those that are described herein may also occur and that the design of the hardware and operating software would be performed so as to account for these situations. They are not described, or not described in detail so as to focus on the salient aspects of the device and system.

A plurality of NAND Flash memory chips may be assembled into a storage system. The interface between the memory controller, which may be a RAID controller, and the memory chips may be configured to improve the overall performance of the system in terms of read and write bandwidth, particularly when random address sequences are encountered. The effectiveness of partial page reads may be improved as well. Here we use a system component termed a PHY interface analogous to the approach commonly used in defining protocol stacks. The PHY layer is the interface between the device such as the NAND Flash memory chip and the using system. This is equivalent to the lower layers of the Open Systems Interconnection (OSI) protocol.

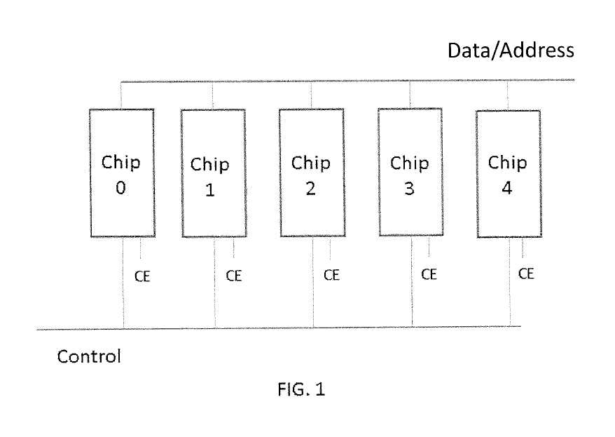

The PHY architecture described facilitates the efficient use of the capabilities of a multi-chip Flash memory module. A block diagram of a multi-chip Flash memory circuit is shown in FIG. 1. Such a circuit is often sold in a package suitable for mounting to a printed circuit board> However, the circuit may be available as an unpackaged chip to be incorporated into another electronic package.

Each chip may have at least the following states that may be of interest

Erase

Read (from memory cells to buffer)

Read data status (in buffer)

Read-data (from buffer to PHY)

Write (from buffer to memory cells)

Write status (in buffer or complete)

Receive write data (to butter from PHY)

Chip enabled (or disabled)

The chip enable is used to select the chip of a plurality of sharing a common bus to which a command has been addressed. In this example, it may be presumed that the appropriate chip enable line has been asserted, and the appropriate command has been sent. After the response, if any, to the command has been received by the PHY layer, the chip enable may be de-asserted.

The individual chips of a memory package can perform operations or change state independently of each other. So, for example, if chip 1 has been enabled and sent an erase command, chip 1 will execute the command autonomously. While there may be provisions to interrupt an erase command, the present discussion elects to treat an erase and actual write or read operations between the buffer and the memory as non-interruptible, for simplicity of presentation. This is not intended to be a limitation on the subject matter disclosed herein.

Instead of assigning specific time durations to the execution of operations, one may consider that the salient operations of the chip may be described as parameterized by Tr (read full page from memory to buffer), Tt (data transfer of a full page over the shared bus), Tw (write full page from buffer to memory) and Te (erase block). Status check operations are presumed to be completed in a time that is negligible compared with the above operations.

Effective operation of a group of FLASH memory chips relates the relative time costs of the main operations stated above and the characteristics of the operation (e.g., interruptible or non-interruptible), or whether partial page operations are permitted (e.g., reading a sector of a page)

For purposes of discussion, one may relate the times of the parameterized operations as approximately 1 Te=3Tw=10 Tt=40 Tr. Recognizing that Te only requires the transmission of a command on the bus and no data, the bus utilization for erase operations is small, but the time to complete such an operation is the largest of any of the individual operation types. That is not to say that erase operations may be performed without impact on the system, as a request for data made to any memory location page on a plane of a chip having any block thereof being erased would be delayed until completion of the Te. However, methods of masking the erase operation in a RAIDed memory system are known, as described in described in U.S. Ser. No. 12/079,364, entitled “Memory Management System and Method”, filed Mar. 26, 2008, which is commonly owned and is incorporated herein by reference, and a high performance system may employ such techniques. So, the focus here is the minimization of the latency due to sharing a common data transfer bus, and the optimization of the rate of data transfer over the bus. Only a few examples are mentioned, and a user will employ the capabilities of the physical layer (PHY) in a manner that is consistent with the specific system design criteria for a particular product.

When data is written in full pages to a memory chip, the total time to complete the operation is Tt+Tw; however, the bus is occupied only for Tt (about ⅓ of the total time for a write operation to a chip for currently available products). Consequently, in this example, about 3 data pages may be transmitted over the bus during the average time to write a single page to a single chip, providing that the number of sequential writes is large (e.g., 10). For example, 10 pages may be written in 10Tt+Tw=13 Tt rather than 10 (Tt+Tw)+40 Tt. That is, about 3 times as many pages may be transmitted and written during the time that one of the other chips is performing an erase operation (recalling that Te=10 Tt and Tw=3Tt).

In another aspect, a read operation may be desired during a bust of write operations. This may be for any reason, including refreshing memory, garbage collection, or metadata maintenance. The PHY described herein has the capability of executing a different command even when a bus transfer for writing is occurring. That is, the write data transmission from the PHY to the selected chip may be suspended, and a command such as READ may be issued to a chip that is not either in the process of receiving the data being written or in process of a block erase. The chip that is the object of the READ command has the chip enable asserted and receives the command. The chip may perform the READ command, for example, while either the write data transfer is resumed, or a READ command sent to another chip. The resumed write data transfer may be interrupted a plurality of times to issue READ commands, but eventually completes the originally initiated data transfer. A WRITE command may be issued to the chip so that the data loaded into the chip buffer may be stored to the memory cells.

Some FLASH chips may have a page buffer for immediate access to the memory cells and a data cache for interface with the data bus. In such a circumstance, data to be written to the memory cells may be transferred from the data cache to the page buffer; the data cache may receive another page of data while the previous page of data is being written to the memory cells.

When the bus is not transferring data to be written (or the write data transfer has been interrupted), the chips that previously received READ commands may be polled to determine if the data has been read from the memory cells into the page buffer or available in the chip data cache. This data may be transferred over the bus to the PHY without the latency of the actual read operation, as the READ command has already executed. While Tr is small compared with Tw, an improvement in latency may nevertheless be obtained.

The characteristics of the PHY described herein permit the adaption of the device, which may be an ASIC, FPGA or other electronic circuit so as to interface with a variety of FLASH chips, which may be amalgamated into a multi-chip memory circuit using a shared bus. The ASIC, FPGA or the like may also perform the functions of the controller, which may be a memory controller. The ability of the PHY to manage an interrupt of a data transfer so as to issue a secondary command, and to then resume the data transfer permits optimization of the use of the shared bus and reduction in latency.

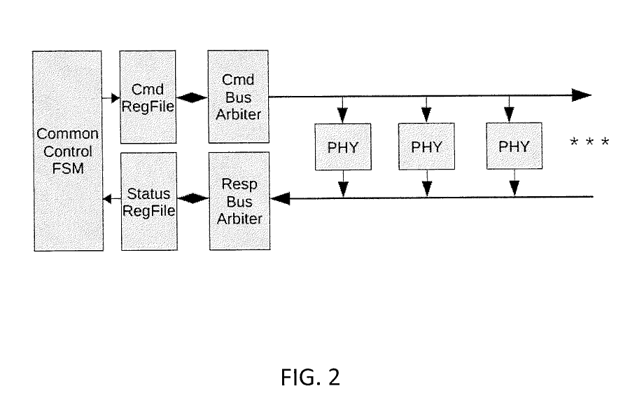

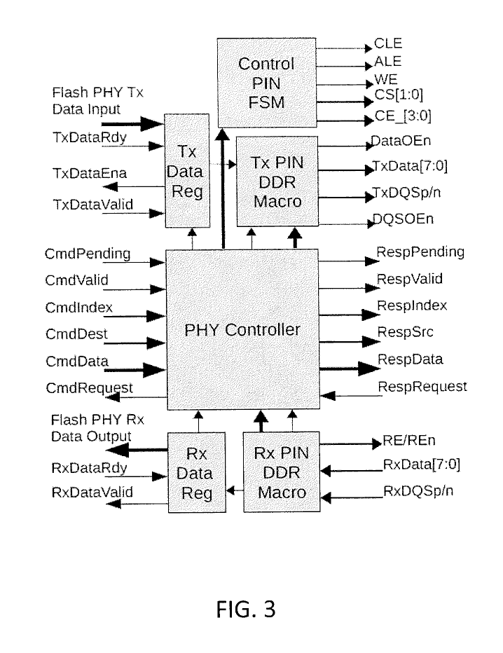

A plurality of PHY interfaces may be controlled by a shared command bus protocol and disposed as shown in FIG. 2. Each PHY interface is comprised of the functional modules shown in FIG. 3 that translate the functional commands received from the controller into electrical signal sequences suitable for the particular NAND FLASH product being used.

When a Write command is received from the controller, and typically while the data is being encoded for transmission, a common Control FSM builds a command structure for the indicated PHY interface into the Common Control Register File. When the WRITE data buffer is complete for a particular PHY interface, the common Control FSM asserts a direct “Command Pending” signal to the associated PHY. The PHY responds with “Command Request,” and after any arbitration arising from the operation of the other PHYs, the common Control Register File issues the PHY command bytes marked with “Valid, Index, and Destination” codes.

The “Destination” code selects the specific PHY. The selected PHY accepts the command structure and executes the WRITE command. The PHY requests data from the Tx Buffer that is currently connected. The specific bus type connecting the PHYs to the controller may be selected depending on the number of PHYs, the performance requirements, or the like. In an example, the interconnection bus may be a time division multiplexed (TDM) bus and the PHY only uses a TDM time slot assigned to the received WRITE Command. During a WRITE Command, the common Control FSM may have additional commands for a different chip connected to the active PHY interface. While still executing the previous write command (data transfer), the PHY controller may assert “Command Request” and receive a second command.

The second command is addressed to a second chip; and, depending on the program logic and the current state, the current WRITE data transfer can be interrupted. When a WRITE data transfer is interrupted, in-progress receipt of data from Tx Buffer stalls and the PHY interface DQS lines stop toggling. The PHY controller sends the second command to the addressed second chip (also known as a DIE) by asserting a different (chip) SELECT signal. After the command has been issued, the PHY controller may resume the data WRITE data transfer by de-asserting the second DIE SELECT line and re-asserting the WRITE DIE SELECT line of the first DIE.

During WRITE Commands, the PHY controller may issue Tx Data READ requests by asserting the TxDataEna signal When the PHY controller stalls the WRITE data transfer, the TxDataEna signal is de-asserted; however, previously accessed data in the pipeline continues to propagate to the PHY controller. After N (a parameter which may be device dependent) samples in the internal FLASH memory pipeline are flushed, the transfer is completely stalled and the PHY may invoke the secondary command. Secondary commands may not perform data operations from the Tx Buffer, but supply commands that provide operands through the common command bus. When the Tx Buffer level drops below M (a parameter which may device dependent) samples, and the end-of-packet (EOP) marker is not yet registered for the current packet, the TxBuffer de-asserts the TxDataRdy signal. In the PHY controller, this event interrupts the normal transfer process until TxDataRady is re-asserted. Note that the PHY transfer process may not stop immediately and hence M samples of backlog may be provided to avoid underrun from the Tx Buffer output and invalid data at the FLASH WRITE interface.

During READ Commands, the PHY controller issues a READ bus transaction to the indicated FLASH device. Reads are followed by POLL commands to confirm that the previous command has finished. A POLL result is sent via the common Response Bus shown in FIG. 3. In a similar way, any PHY with a pending command response asserts the “RespPending” signal. The common Control Response Arbiter eventually selects the Pending device by asserting “RespRequest”. The Pending device then drives the response data with an index and source address code onto the response bus.

When READ Data is available in the FLASH device register or buffer, the common Control FSM issues a READ Data Transfer command to the PHY Controller. The PHY Controller issues the FLASH commands to access the READ data. The data is packed as necessary and then sent over the TDM FLASH PHY Rx Data bus, and into the recipient Rx Buffer with RxDataValid asserted for each valid data bus item.

It may be desirable to have the ability to alter the pin transition state machine used to command and interface to the FLASH devices. Since the specific waveforms needed to provide the commands and data to the chips, and to receive status and data from the chips is not standardized, the ability to adapt the memory controller to interface with such devices is useful. Typically each manufacturer has certain differences in protocol that may need to be accommodated, or new commands or hidden commands that may become available.

Within each PHY controller may be a small micro_Code table loaded during initialization allowing the main application to specify how the FLASH is accessed. This table may be loaded across the common control bus and be verified over the common response bus.

A microSequencer Engine (μSEQEng) executes the main control microcode and provides timers, looping, and branching capabilities. The Executive (Exec) FSM is the overall controller of the module that handles initialization and status access as well as command parsing and execution. The Command I/F is an interface that follows the Central Command Bus protocol, retrieves commands from the master control FSM, and transfers requested status to the master control FSM

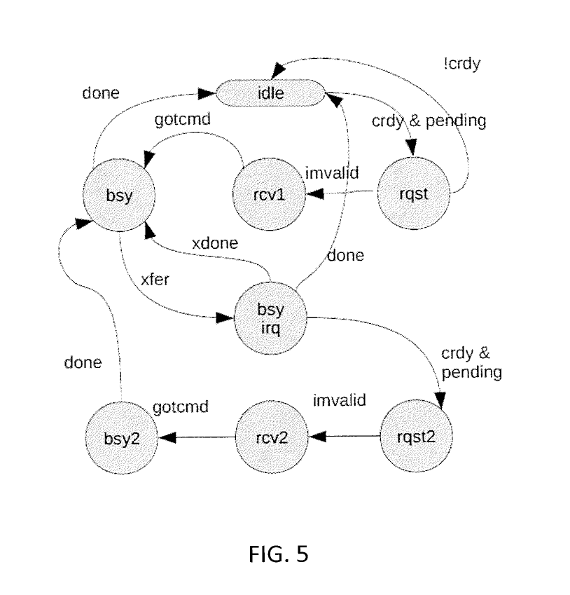

The central command bus may be, for example, a 32-bit interface that supplies a burst of information to each PHY containing opcodes and command parameters. The Command Interface is the logic that responds to the shared central command bus control signals to extract commands directed to a selected PHY, and to send status from the selected PHY when enabled to do so. An example of a protocol flow chart is shown in FIG. 5. When the ctrl_phy_cp signal is used, the captured data may be loaded into a separate context for register and SRAM access.

When the central control asserts crdy (Command Pending) to the PHY controller, the “rqst” state issues the “Command Request”. When the central arbiter can send the command to this PHY, the “Command Valid” is asserted with each of a variable number of command words transferred and the “rev1” state collects the 2, 3, or 4 32-bit command data words. When Command Valid is de-asserted, the “gotcmd” transition to the active command state “bsy” is initiated. While in “bsy” the PHY controller will not respond to any additional commands. The PHY controller may enter a data transfer state and asserts a status signal allowing transition to the “bsy_irq” state; and, from this state, to prevent head of line blocking of long latency commands, the PHY controller may accept new commands to access a different device in the memory package. If another command is pending from central control, the “rqst2” state is entered to accept a second command context from the central bus. The arrival of the second command context (the Ancillary Context) sets an IRQ request to the microsequencer. The main microsequencer program will have already indicated the ability to stall the current context and will transition to an idling loop so that the new command can be executed. While the second command is running, there may be no interruptions until execution thereof is complete.

After the secondary command has finished, the original command will resume; and, depending on the size of the data transfer operation, the command may be in an interruptible state additional times. Ancillary commands are typically used to issue Reads to the FLASH and to obtain Status from the FLASH to support Polling operations from the PFC. The READ command results in the data being transferred to the chip buffer, and a separate command initiates the data transfer from the chip to the PHY.

The Command Interface may hold two concurrent command contexts at any time; the primary and the ancillary. Ancillary contexts may be discarded prior to returning to the primary context.

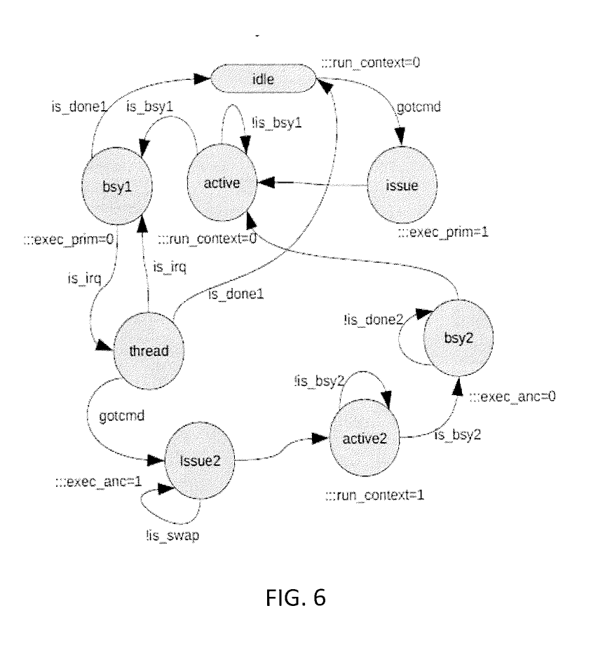

The commands issued by the PFC are each specified by an address. The microSequencer executes at the address where a branch instruction redirects program execution to the necessary microcode. By using a jump table method, microcode may be revised as required without having to alter the PFC design. A “devsel” field may be used to define the CS (chip select) pin pattern to select the FLASH package and DIE. This code is determined in the FLASH Manager physical lookup result. The FLASH command parameters may be either Address Bytes or Set Feature control bytes. For example, a FLASH Read operation may start with the command byte 0x00 followed by C1, C2, P1, P2, P3 address bytes, followed by another command of 0x30. From the original data context header supplied by the PFC, the central controller extracts the generic operation and the page/column address information and supplies these data within the command bus transfer. The actual FLASH device command bytes (0x00 and 0x30) may be embedded in the microcode since the code sequence and commands sent define the FLASH operation. The main state machine virtually mirrors the actions at the Command Interface as shown in FIG. 6.

FLASH commands invoke microcode and follow a path to allow multi-context execution. FLASH commands that return Status or Configuration data from the FLASH memory generate a response buffer before issuing the “Done” command. The Command Interface may be signaled at the end of each command to issue a “Cmd Done” response code. When there is a response buffer, the RespValid line may be asserted long enough to transfer the response buffer with the CmdDone response code. Under control of the microprogram, the executing code enables the interrupt for the secondary command; this status bus information controls when the ancillary command subroutine call is executed, since there may be sections of the FLASH protocol that cannot be interrupted. These constraints can be imparted into the microcode program specific to each type of FLASH device. The Exec FSM maintains a run_context flag that is based on which command is being executed. Typically run_context will be zero (the primary command), if the microcode permits, by setting the exec_state==IRQ the Exec FSM will request another command. If another command is subsequently received, an interrupt occurs, and the sequencer state is monitored until it gets to SWAP. The sequencer then transitions to BSY2 (BSY2 is logically generated from generic uCode BSY combined with run_context=1). When the second context command is finished the sequencer state moves to DONE2 and dwells to allow the Exec FSM to toggle the run_context flag==0. The sequencer then transitions from DONE2 to BSY1 (BSY1 is logically generated from generic uCode BSY combined with run_context=0). From this state the microcode execution continues by re-priming the data pipeline and reentering the main data loop.

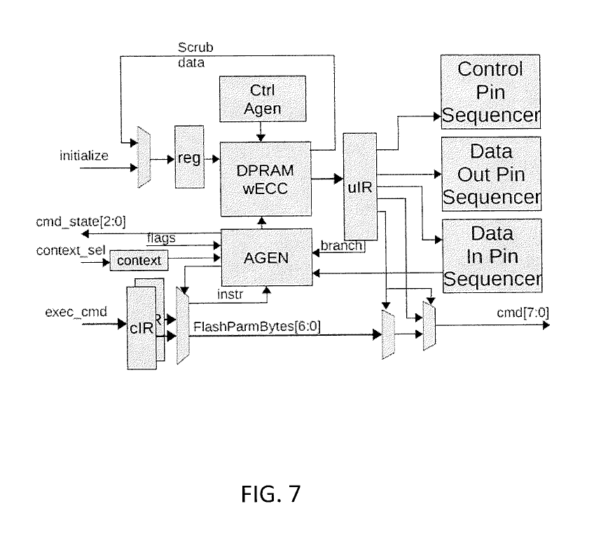

The MicroSequencer utilizes a control store that may provide timer, looping, and branch control, and microCommands to each of the Pin Sequencers contained in the PHY Logic. The top level diagram of the sequencer is shown in FIG. 7.

When the device is initialized, the configuration data may include the microcode that is loaded into the DPRAM. The command-Instruction Register may be loaded by the ExecFSM and contain the microsequencer start address and the parameter arrays (Address or Configuration Data). There may be, for example, one or two active command contexts issued by the ExecFSM: the Primary and the Ancillary. The control of the microprogram may be context switched to the Ancillary command if the Primary command characteristics permit. There may be specific locations in the microprogram where a branch can occur to alter the normal flow of the instruction. Execution of the branch may terminate in an interface idle condition so the original command is not disturbed. When the Ancillary command is finished, the context may be restored and the microprogram written to re-establish the pre-empted (typically a data transfer) state and continue the operation. Each command completion, or the sequencer's ability to service an ancillary instruction from the Exec FSM may be signaled at the cmd_state[ ] output. The micro-Instruction Register may provide the micro-control information on each clock, or over several clocks while waiting for a timer event.

The Executive FSM selects a microprogram based on the macro function to be performed. With the microprogram instruction, the Exec FSM also provides command parameters in the form of an array of FLASH Address Bytes. As the selected microprogram executes, the various address bytes as required to implement the desired FLASH operation are selected. To implement a FLASH Configuration command, the Executive FSM selects the appropriate command code, device selection, and any necessary Address or Configuration Data bytes. For example, to set the output drive using the Set Feature microinstruction, the ExecFSM supplies 0x10 as the address of the Driver Strength Register, and then the configuration data.

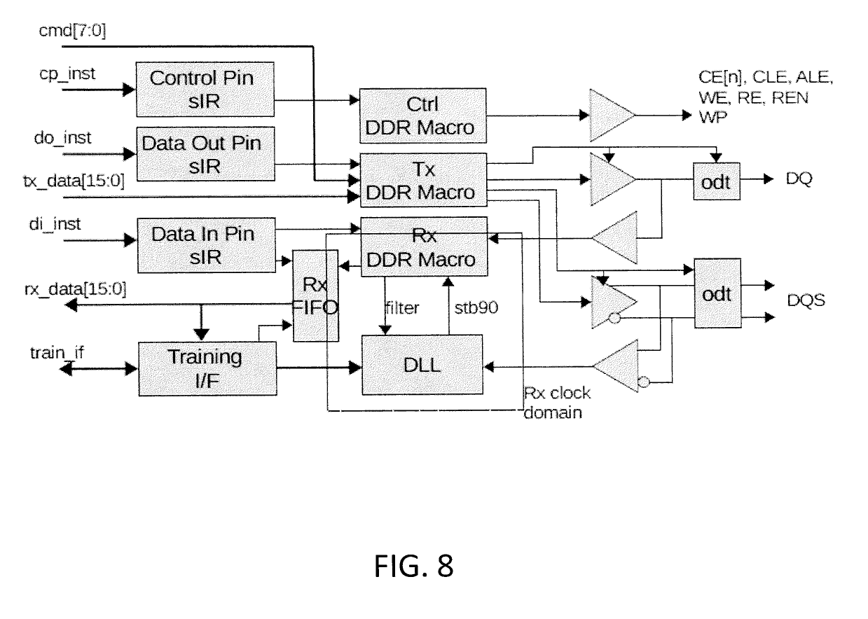

The PHY Logic is shown in FIG. 8. During control transfers, the control pins are driven directly from the sequencer instruction registers while the DQ lines are driven with the FLASH Command or Address information provided on cmd[7:0]. Note during control cycles, the Tx DDR Macro does not toggle at DDR rate. During write data transfers, the DQ and DQS outputs are enabled, the ODT is disabled and write data provided on tx_data is driven onto DQ while DQS toggles according to do_inst sequencer instruction. In an example, during a 24 nm FLASH Toggle read data transfer at 400 Mbps, the DQ and DQS outputs of the PHY may be disabled, the ODT may be enabled. When transitions are received on DQS from the FLASH device, a DLL may shift the edges based on the delay established during training and provides a clock pulse on “stb90”. The shifted edges may be used to clock the Rx DDR Macro to sample the DQ inputs and recover the FLASH Read data. The Rx Data word is transferred to the Rx FIFO. Later, the RxData Interface requests the read data from the Rx FIFO using the core clock. The output pins defined in Table 1 are driven by the microprogram pin sequence components of each programmable instruction. The input pins may be either DQS or DQ. DQS is time shifted to provide an input sampling clock. The DQ pins are captured by input DDR macros using the DQS_in a derived clock.

TABLE 1
Example of FLASH interface pins and timing information.

| Pin Name | Description | Timing Values associated |
|---|---|---|
| CE | Chip Enable, output active Low | Tcr for Read, Tcs2 for Write |
| CLE | Command Enable, output active High | Tcals2 for write |
| ALE | Address Enable, output active High | Tcals2 for write |
| REn/RE | “REN” Read Enable, output, idles | Trpre2, Treh, Trp, Trc, Tdqsre, |
| | High low = preamble, first rising | Trpst Trpsth |
| | is data trigger | Twhr, Tar |
| DQS/DQSn (input for Read) | Data strobe, driven low during | Tdqsre, Tdqsq, Tqh, Tqhs, Tdvw, Tchz |
| | preamble, rising/falling edge frames a | |
| | read data transaction | |
| DQS/DQSn (output for Write) | Data strobe, idle high driven low | Tcdqss, Twpre2, Tdsc, Tdqsh, Tdqsl, Tds, |
| | during preamble, rising/falling edge | Tdh, Twpst, Twpsth Tcs2, Tcals2, Tch, |
| | mid-Write Data pulse | Tcalh, |
| WEn | Write Enable, output for CLE or | Twp, Tcas, Tcah, Tcals, Tcalh, Tcs, Tch |
| | ALE = 1, idles High, goes low, data | |
| | sampled on rising edge. We rising | |
| | after Tcals, Tcs, and Twp | |
| Ren and DQS DQSn for Read ID | As above except data is not DDR, it is | Twhr, Tar - delays after |
| operation | designed for mid-pulse rising edge | command/address write before Ren |
| | sampling | should go low to read lds |
| Status Read (toggle mode is on, | RE as in ID case above, only one pulse | No Post Amble, RE stays low until CE |
| command in only | needed. | returns high |
| | DLL is not needed but still could be | |
| | used SDR DQ | |
| Status Read (before Power Up | RE goes low Twhr after WE goes high | Tcalb + Tclr, Twhr, Trpp |
| sequence) | (command input), RE stays low Trpp, | |
| | then returns high to sample the Status | |
| | Out. No postamble. | |
| WE n Set Feature command | WE toggles twice for command 0xEF | Tcdqss, Tcals, Twpre |
| | and then feature address, DQS/DQSn | |
| | out must be driven to idle Tcdqss | |
| | before ALE drops. | |

The duration of signal active cycles is controlled by the number of microprogram instructions and the data patterns defined therein. However, there are certain cases where a time delay can be used instead of exhausting the microprogram store to implement wide active pulses or delays between pulse events.

The Timer1 Delay, and Timer1 Range fields provide the ability to assert a signal, hold, and then de-asert a signal with just 2 microinstructions. The timer capabilities are shown in Table 2.

TABLE 2
MicroSequencer Timer Resolutions

| | Timer1 | Max Delay |
|---|---|---|
| Timer1 Condition | Range | Value (ns) |
| 400 Mbps (1, 3, 5, . . . 15) odd only | 0 | 37.5 |
| 133 Mbps (1, 3, 5, . . . 15) odd only | 0 | 112.7 |
| 400 Mbps (1, 2, 3, 4, . . . 15) any value | 1 | 75 |
| 133 Mbps(1, 2, 3, 4, . . . 15) any value | 1 | 227 |
| 400 Mbps(1, 2, 3 . . . 15) any value | 2 | 150 |
| 133 Mbps(1, 2, 3, . . . 15) any value | 2 | 454 |
| 400 Mbps(1, 2, 3, . . . 15) any value | 3 | 300 |
| 133 Mbps(1, 2, 3, . . . 15) any value | 3 | 909 |

If longer delays are needed, two delays can be abutted, or Timer2 (Counter mode) may be used to count a slower event. Timer2 can also be used to count events before a program can proceed. An event can be, for example, either a High to Low, or Low to High transition on the R/BN signal.

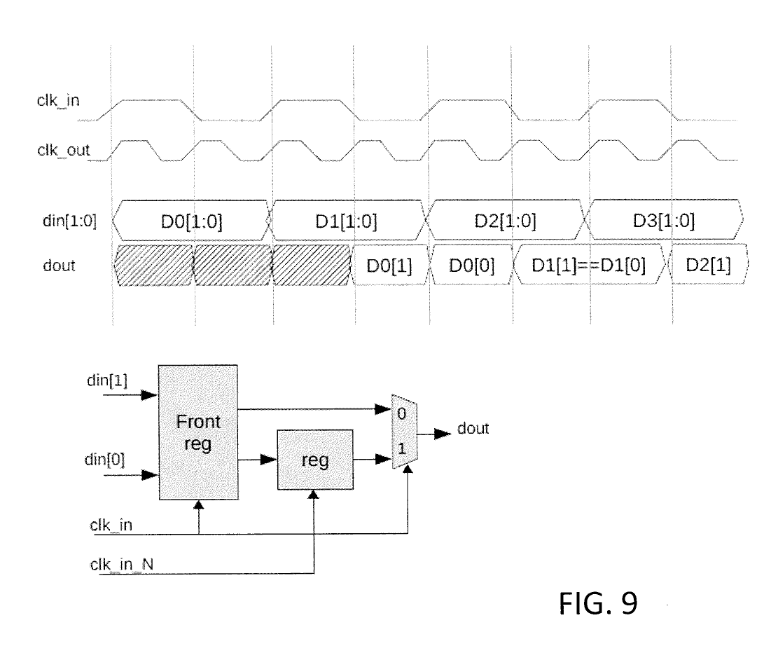

The Control and DQ pin output DDR Macro logic is similar. The DQ version has the data mux for either the command byte or the actual 16-bit write data. A DDR macro is a 2:1 clock step exchange register as shown in FIG. 9. On the ingress clock two bits of information are loaded into a register. During the first half cycle, the mux selects the previous di-bit 2^{nd} phase from the falling edge triggered holding flip flop. The output pin is protected from transient settling effects at the rising edge of clk_in. The output mux allows bit[1] of the current di-bit to propagate to the output for the second half cycle. On the falling edge of the input clock, the current di-bit bit[0] is transferred to a holding register while the mux selects the stable bit[1] value. During command cycles, and set feature commands, when SDR mode may be desired, the same value is loaded into din[1] and din[0]. The net result is a constant output for a full clock cycle.

To create the required phase relationship between DQ and DQS for writing data to FLASH, the DQ macro is fed with a 0 deg clock, while the DQS macro is fed with a 270 deg clock (phase with respect to microsequencer) This relationship provides a full clock cycle for the DQ data input resolution delay, and % clock cycle decoding of the DQS macro data select input code and so is less constrained by an ECC correction delay.

Data can be sampled from the DQ pins using the DLL shifted clock rising edge (SDR), using the DLL shifted clock rising and falling edges (DDR mode), using the direct DQS input rising edge, or using the direct DQS input rising and falling edges. These various modes may be needed to accommodate the differing approaches of transferring data read from the FLASH to the controller, depending on the manufacturer and specific architecture of the chip. Polling, GetFeature Data, and GetID data may not use the same timing as the normal READ data and the action of the READ data interface depends upon how the FLASH has been configured with the SetFeature command.

The Tx Data Interface, receives FLASH WRITE data from the Tx Buffer. The Tx Data interface is clocked at ½ the FLASH data bit rate for 400 Mbps mode (i.e. 200 MHz).

During a Tx Data Transfer, the TxD_Ena signal is asserted when TxD_Rdy is asserted. There is a predetermined pipeline delay of X TBD cycles before the TxDataValid is asserted on the selected source bus, and TDM time slot. Any valid Data Received is transferred to the PHY tx_data lines. Generally, when a WRITE operation starts, the data is pulled in a continuous manner from the Tx Buffer. However, when Ancillary commands are executed, the Tx Data stream is paused to permit transmitting the command into another device, which may be a chip. In preparation of the context swap, the microsequencer may de-assert the TxD_Ena signal and the pipeline from the TxBuffer to the PHY will be flushed. That last transfer occurs to the FLASH and the bus may be placed in an idle state. When the Ancillary command is finished, the original context is restarted and the TxD_Ena signal is re-asserted. The process repeats until all of the pending data has been transferred. Note that since the Tx Data pipeline is filled and flushed each time a context is swapped, the average data transfer rate is reduced; however, the overall, the system performance is increased due to enhanced parallelism.

The Rx Data Interface operates in a manner similar to the Tx Data interface but transfers data to the Rx Buffer.

The RxBuffer may be configured to de-assert RxD_Rdy when there is less room in the buffer than the roundtrip backpressure pipeline delay data equivalent. There are N clock cycles in the backpressure path, so a reserve of 2*N bytes may be used.

The Read Data transfer may not begin unless the RxBuffer RxD_Rdy[p], for the assigned Source Channel “S” and TDM timeslot (as applicable), is asserted. While the data is in transit from the FLASH memory circuit to the Rx Buffer, the RxData Interface asserts RxDataValid. If there is an interruption in the flow of READ data (due to an Ancillary command execution), the RxDataValid is de-asserted when there is no data. If however, the RxD_Rdy signal is sampled in the low state, the microsequencer may commence a bus stall and hold until the RxD_Rdy has be re-asserted. In this example, in most instances, the data will be transferred in total as the RxBuffer has an aggregate time bandwidth product sufficient to accept at full line rate (e.g., 10 PHY @ 400 Mbps).

Although only a few exemplary embodiments of this invention have been de-scribed in detail above, those skilled in the art will readily appreciate that many modifications are possible in the exemplary embodiments without materially departing from the novel teachings and advantages of the invention. Accordingly, all such modifications are intended to be included within the scope of this invention.

What is claimed is:

1. An apparatus for storing digital data, comprising,
a controller;
a flash memory controller in communication with the controller and the flash memory controller in communication with a plurality of flash memory circuits,
wherein a write data transfer between the flash memory controller and a flash memory circuit of the plurality of flash memory circuits is interruptible.

2. The apparatus of claim 1, further comprising the plurality of flash memory circuits,
wherein the flash memory circuit has a plurality of memory chips sharing a common bus.

3. The apparatus of claim 1, wherein a write data transfer is interruptible when a read command is received by the flash memory controller and is directed to a same flash memory circuit as the write data transfer.

4. The apparatus of claim 3, wherein the write data transfer is interruptible to poll the flash memory circuit for completion of the read command.

5. The apparatus of claim 4, wherein the write data transfer is interruptible to permit transfer the results of a completed read command from a buffer of the flash memory circuit to the flash memory controller.

6. A method of managing a flash memory device, comprising:
providing a processor operable to manage a queue of read requests, write requests and data associated with the write requests;
transmitting the write request and the associated data to a flash memory interface;
sending a read request to the flash memory interface and:
determining if a write data transfer is in progress to a same memory circuit as is identified by the read request and:
interrupting the write data transfer to send the read request to the flash memory circuit;
resuming the write data transfer;
waiting for an estimated time to perform the read request;
determining if a write data transfer is in progress;
interrupting the write data transfer;
polling the memory circuit to determine if there is data in a read buffer; and, if data is in the read buffer, transferring the data from the read buffer to the flash memory interface; and
resuming a previously interrupted write data transfer.

7. The method of claim 6, wherein the write data is transmitted to the flash memory interface prior to transmission of a corresponding write command.

8. An apparatus for interfacing with a FLASH memory circuit, comprising:
a controller configured to queue READ and WRITE commands and associated WRITE data, and to receive data in response to a READ command, the controller being adapted to interface with a user and with a physical layer interface (PHY); and
a PHY comprising a state machine executing a microcode program and configured to provide signals for controlling a FLASH memory circuit having a plurality of chips and for transmitting and receiving commands and data on a FLASH memory circuit bus interface;
wherein the PHY is operable to interrupt a data transfer to the FLASH memory circuit to permit the execution of an other command and to resume the data transfer after completion of the other command.

9. The apparatus of claim 8, wherein the data transfer is data to be written to a chip of the FLASH memory circuit, and the other command is selected from a READ command, a POLL command, or a READ data transfer command, and directed to the FLASH memory circuit.

10. The apparatus of claim 9, wherein the POLL command determines data has been read from the chip and is available in a buffer associated with the chip.

11. The apparatus of claim 8, wherein commands and data are transmitted on a same bus.

13. The apparatus of claim 8, wherein the microcode program is loadable.
